(19) United States
(12) Patent Application Publication
(10) Pub. No.: US 2024/0409362 A1
(43) Pub. Date: Dec. 12, 2024

(54) MONITORING OF ELEVATOR PIT TIE-DOWN AND COMPENSATION

(71) Applicant: Otis Elevator Company, Farmington, CT (US)

(72) Inventors: Randy Roberts, Hebron, CT (US); Johanna Whitwell, Hartford, CT (US); Craig Drew Bogli, Avon, CT (US)

(21) Appl. No.: 18/333,108

(22) Filed: Jun. 12, 2023

(51) Int. Cl. B66B 5/00; B66B 7/10

(52) U.S. Cl. CPC B66B 5/0018; B66B 7/10

(57) ABSTRACT

A method of monitoring a tie-down compensation of an elevator system includes positioning one or more sensor assemblies in a hoistway of the elevator system. The sensor assemblies are configured to monitor a position of the tie-down compensation in the hoistway. The tie-down compensation has a compensation member of the elevator system routed therethrough. A distance between a fixed location in the hoistway and the tie-down compensation is measured via the sensor assemblies, and the measured distance is compared to a threshold distance. One or more actions is taken based on a result of the comparison.

### BACKGROUND

The embodiments herein relate to elevator systems, and more particularly, to an elevator system including one or more sensor assemblies to detect a person in a pit of the elevator system.

Persons, such as maintenance personnel, may need to enter the pit of an elevator hoistway for inspection, maintenance, etc. Numerous safety measures exist to prevent injury to persons in the pit. Additional safety measures, although not necessary, may be beneficial.

### SUMMARY

According to an embodiment, an elevator system includes a hoistway, an elevator car configured to travel in the hoistway, and a counterweight located in the hoistway. A tension member connects the elevator car to the counterweight and is configured to move the elevator car along the hoistway. A pit is located at a bottom of the hoistway and a compensation member extends from the elevator car toward the pit and from the pit toward a counterweight. A tie-down compensation is located in the pit, and the compensation member is routed therethrough. One or more sensor assemblies are configured to monitor a position of the tie-down compensation in the hoistway.

In addition to one or more of the features described herein, or as an alternative, in further embodiments the sensor assemblies include a sensor that measures a distance between a fixed location in the hoistway and the tie-down compensation.

In addition to one or more of the features described herein, or as an alternative, in further embodiments the sensor includes at least one of a light detection and ranging (LIDAR) sensor, a millimeter wave (radio assisted detection and ranging) RADAR sensor and a red, blue, green depth (RGBD) camera.

In addition to one or more of the features described herein, or as an alternative, in further embodiments a running average of measured distances is indicative of movement of the tie-down compensation in the hoistway.

In addition to one or more of the features described herein, or as an alternative, in further embodiments a run-to-run difference in measured distance is indicative of damping performance of the tie-down compensation.

In addition to one or more of the features described herein, or as an alternative, in further embodiments the sensor is fixed in the hoistway and measures a position of the tie-down compensation.

In addition to one or more of the features described herein, or as an alternative, in further embodiments the sensor is fixed to the tie-down compensation and measures a distance to the fixed location in the hoistway.

According to another embodiment, a method of monitoring a tie-down compensation of an elevator system includes positioning one or more sensor assemblies in a hoistway of the elevator system. The sensor assemblies are configured to monitor a position of the tie-down compensation in the hoistway. The tie-down compensation has a compensation member of the elevator system routed therethrough. A distance between a fixed location in the hoistway and the tie-down compensation is measured via the sensor assemblies, and the measured distance is compared to a threshold distance. One or more actions is taken based on a result of the comparison.

In addition to one or more of the features described herein, or as an alternative, further embodiments include calculating a running average of the measured distance, comparing the calculated running average to the threshold distance, and shortening an effective length of the compensation member as a result of the comparison.

In addition to one or more of the features described herein, or as an alternative, further embodiments include comparing measured distances on a run to run basis, and taking one or more actions based on the compared measured distances.

In addition to one or more of the features described herein, or as an alternative, further embodiments include determining one or more of a velocity or acceleration of the tie-down compensation, comparing the velocity or acceleration to a threshold, and taking one or more actions based on the compared velocity or threshold.

In addition to one or more of the features described herein, or as an alternative, in further embodiments the one or more actions includes replacement or replenishment of fluid in a hydraulic damper of the tie-down compensation.

In addition to one or more of the features described herein, or as an alternative, in further embodiments the sensor assembly includes at least one of a LIDAR sensor, a millimeter wave RADAR sensor and an RGBD camera.

In addition to one or more of the features described herein, or as an alternative, in further embodiments the sensor assembly is fixed in the hoistway and measures a position of the tie-down compensation.

In addition to one or more of the features described herein, or as an alternative, in further embodiments the sensor assembly is fixed to the tie-down compensation and measures a distance to the fixed location in the hoistway.

According to yet another embodiment, an elevator system includes a hoistway, an elevator car configured to travel in the hoistway, and a counterweight located in the hoistway. A tension member extends between and connects the elevator car to the counterweight. A pit is located at a bottom of the hoistway, and a compensation member extends from the elevator car toward the pit and from the pit toward the counterweight. A tie-down carriage is connected to the compensation member, and the tie-down carriage is configured to be biased downwardly toward the bottom of the hoistway to tension the compensation member. One or more LIDAR sensors are configured to monitor a position of the tie-down carriage in the hoistway.

In addition to one or more of the features described herein, or as an alternative, in further embodiments the one or more LIDAR sensors measures a distance between a fixed location in the hoistway and the tie-down carriage.

In addition to one or more of the features described herein, or as an alternative, in further embodiments a running average of measured distances is indicative of movement of the tie-down carriage in the hoistway.

In addition to one or more of the features described herein, or as an alternative, in further embodiments the one or more LIDAR sensors is fixed in the hoistway and measures a position of the tie-down carriage.

In addition to one or more of the features described herein, or as an alternative, in further embodiments the one or more LIDAR sensors is fixed to the tie-down carriage and measures a distance to the fixed location in the hoistway.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 depicts a compensation and tie-down and compensation arrangement in an exemplary embodiment;

FIG. 3 depicts a sensor assembly disposed in an elevator pit in an example embodiment;

FIG. 4 depicts a sensor assembly in an example embodiment; and

FIG. 5 depicts a method of monitoring a tie-down and compensation arrangement in an example embodiment.

### DETAILED DESCRIPTION

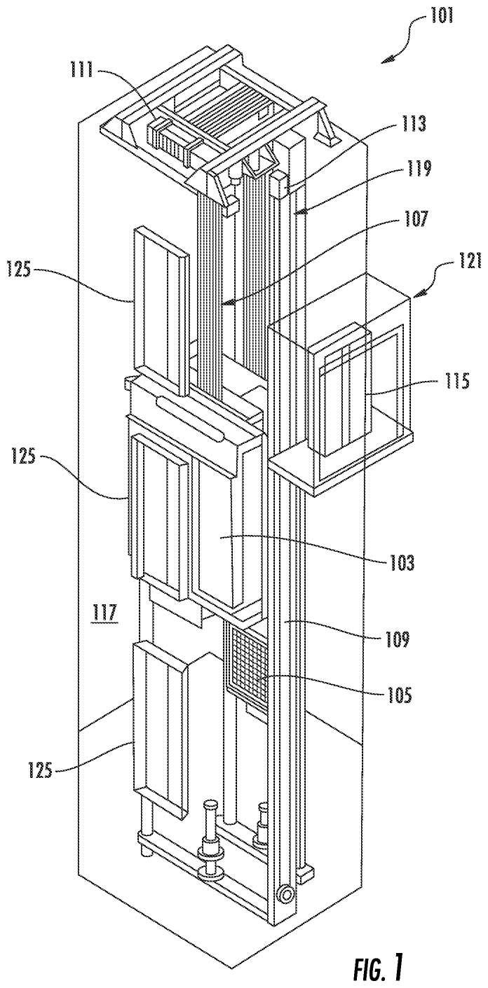

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft or hoistway 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counterweight, as known in the art. For example, without limitation, the position reference system 113 can be an encoder, sensor, or other system and can include velocity sensing, absolute position sensing, etc., as will be appreciated by those of skill in the art.

The controller 115 may be located, as shown, in a controller room 121 of the elevator shaft 117 and is configured to control the operation of the elevator system 101, and particularly the elevator car 103. It is to be appreciated that the controller 115 need not be in the controller room 121 but may be in the hoistway or other location in the elevator system. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller 115 may be located remotely or in a distributed computing network (e.g., cloud computing architecture). The controller 115 may be implemented using a processor-based machine, such as a personal computer, server, distributed computing network, etc.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

The elevator system 101 also includes one or more elevator doors 104. The elevator door 104 may be attached to the elevator car 103 or the elevator door 104 may be located on a landing 125 of the elevator system 101, or both. Embodiments disclosed herein may be applicable to both an elevator door 104 attached to the elevator car 103 or an elevator door 104 located on a landing 125 of the elevator system 101, or both. The elevator door 104 opens to allow passengers to enter and exit the elevator car 103.

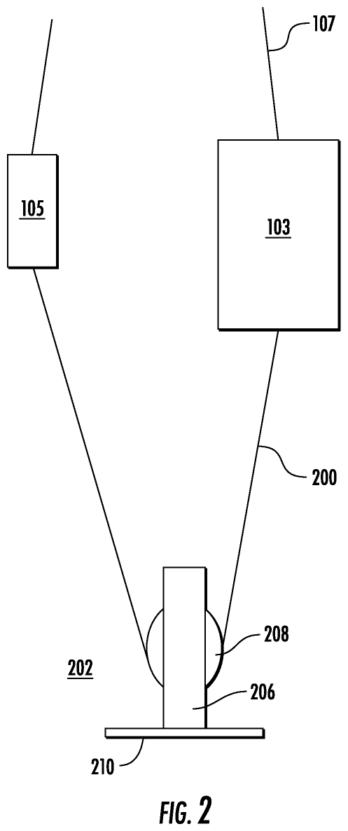

Referring now to FIG. 2, the elevator system 101 includes a compensation member 200 extending from the elevator car 103 toward a hoistway pit 202 around a tie-down compensation 206 and to the counterweight 105. The tie-down compensation 206 is disposed in the hoistway pit 202, and includes a tie-down carriage 208 which is biased downwardly toward a pit floor 210 to tension the compensation member 200, thus stabilizing motion of the elevator car 103 along the hoistway 117. Over time during operation of the elevator system 101, the compensation member 200 stretches or lengthens, and thus the tie-down carriage 208 travels downwardly toward the pit floor 210 to maintain a selected tension on the compensation member 200. Downward travel of the tie-down carriage 208 is, however, limited and an effective length of the compensation member 200 is periodically shortened to maintain the selected tension, while still allowing for travel of the tie-down carriage 208. According to an aspect, a position sensor assembly 220 is provided to monitor a position of the tie-down carriage 208.

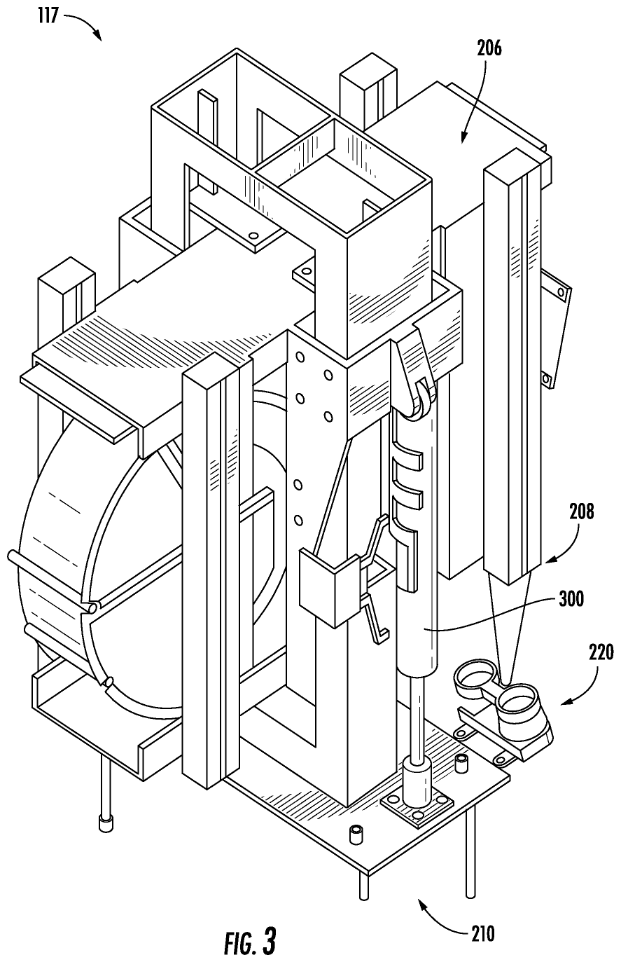

FIG. 3 illustrates the position sensor assembly 220 in detail. The position sensor assembly 220 is fixed in the hoistway 117 and is configured to measure a distance from the sensor assembly 220 to the tie-down carriage 208. When the position of the tie-down carriage 208 is outside of a selected threshold, the effective length of the compensation member 200 is shortened. In some embodiments, the threshold is one or more of a predetermined threshold or may be an installation site-specific threshold. While in the embodiment of FIG. 3, the sensor assembly 220 is fixed in the hoistway 117 and measures a distance to the movable tie-down carriage 208, one skilled in the art will readily appreciate that in other embodiments the sensor assembly 220 may be disposed at the tie-down carriage 208 and configured to measure a distance to a fixed position in the hoistway 117, such as a location at the pit floor 210.

The position sensor assembly 220 is utilized to monitor the position of the tie-down carriage 208 over time, which is indicative of elongation of the compensation member 200, which in some embodiments is evaluated using a running average of measurements of the distance between the sensor assembly 220 and the tie-down carriage 208. Further, the position sensor assembly 220 is utilized to monitor run-to-run variations in the position of the distance, which is indicative of damping performance of the tie-down compensation 206, which utilizes a damper 300, such as a hydraulic fluid damper. A run-to-run variation outside of a predetermined threshold indicates reduced damping performance, and that maintenance of the damper 300 may be required. In some embodiments, the processor 224 may derive a rate of change of position of the tie-down compensation 206 and/or an acceleration of the tie-down compensation 206 to assess the damping performance. While one sensor assembly 220 and one damper 300 is illustrated in FIG. 3, in other embodiments multiple sensor assemblies 220 may be utilized to monitor damping performance of multiple dampers 330, which may be detected by observing rocking or non-uniform movement of the tie-down carriage 208.

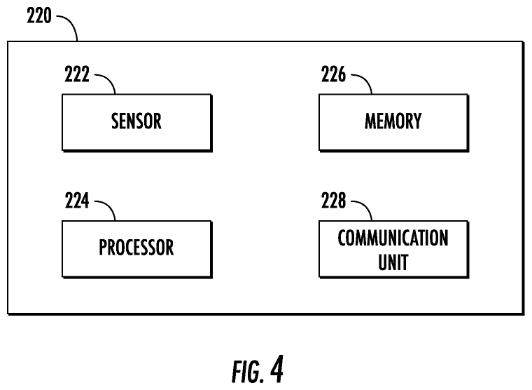

FIG. 4 depicts a sensor assembly 220 in an example embodiment. The sensor assembly 220 includes a sensor 222. The sensor 222 may be a distance sensor that generates distance measurements in a two-dimensional or three-dimensional field of view. The sensor 222 may be implemented using a LIDAR sensor, a millimeter wave RADAR sensor, an RGBD camera or other distance measuring sensors. The sensor assembly 220 includes a processor 224 that controls operation of the sensor assembly 220. The processor 224 may be implemented using a general-purpose microprocessor executing a computer program stored on a storage medium to perform the operations described herein, and in some embodiments may be utilized to perform data and/or image processing of sensor data to extract useful diagnostic signals, such as tie-down velocity or acceleration. Alternatively, the processor 224 may be implemented in hardware (e.g., ASIC. FPGA) or in a combination of hardware/software. The processor 224 allows the sensor assembly 220 to perform computations locally, also referred to as edge computing. The processor 224 can send commands to other components of the elevator system 101 based on a result of the local computations.

The sensor assembly 220 includes a memory 226 that may store a computer program executable by processor 224, reference data, sensor data, etc. The memory 226 may be implemented using known devices such a random-access memory. The sensor assembly 220 includes a communication unit 228 which allows the sensor assembly 220 to communicate with other components of the elevator system 101, such as other sensor assemblies and/or the elevator controller 115. The communication unit 228 may be implemented using wired connections (e.g., LAN, ethernet, twisted pair, etc.) or wireless connections (e.g., WiFi, NFC, BlueTooth, etc.).

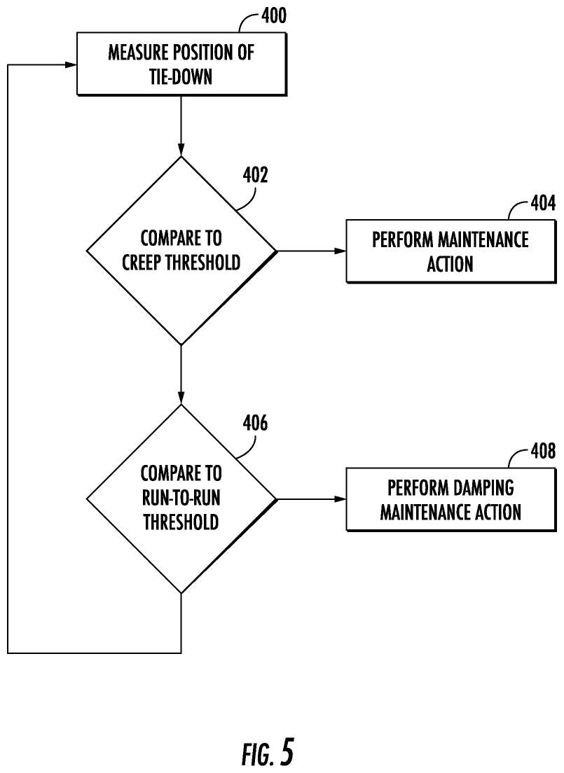

Referring now to FIG. 5, a method of monitoring the position of the tie-down carriage 208 includes periodically measuring a vertical position of the tie-down carriage 208 in the hoistway 107 via a sensor assembly 220 at step 400. The measured positions are compared to a creep threshold at step 402 using, for example, a running average to position measurements. If the measurements exceed the creep threshold, a signal is generated to perform a maintenance action at step 404. The maintenance actions may include inspection of the tie-down compensation 206 and/or shortening an effective length of the compensation member 200. At step 406, run-to-run variation of the position measurements are compared to a run-to-run threshold, and additionally or alternatively a rate of change of position of the tie-down compensation 206 and/or an acceleration of the tie-down compensation 206 may be derived to assess the damping performance. At step 408, when the measure run-to-run variation exceeds the run-to-run threshold, a damping maintenance signal is sent to perform a maintenance action. In the case of run-to-run variation, the maintenance action may be one or more of inspection of the damper 300 and/or replacement or replenishment of hydraulic fluid in the damper 300.

Utilizing the sensor assembly 220 to measure the position of the tie-down carriage 208 allows for monitoring the condition of the compensation member 200 and the tie-down compensation 206 from outside of the hoistway 107, thus reducing the need for a technician to enter the pit 202, thus improving safety for the technician.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An elevator system comprising:
a hoistway;
an elevator car configured to travel in the hoistway;
a counterweight disposed in the hoistway;
a tension member connecting the elevator car to the counterweight and configured to move the elevator car along the hoistway;
a pit located at a bottom of the hoistway;
a compensation member extending from the elevator car toward the pit and from the pit toward the counterweight;
a tie-down compensation located in the pit through which the compensation member is routed; and
one or more sensor assemblies configured to monitor a position of the tie-down compensation in the hoistway.

2. The elevator system of claim 1, wherein the sensor assemblies includes a sensor that measures a distance between a fixed location in the hoistway and the tie-down compensation.

3. The elevator system of claim 2, wherein the sensor includes at least one of a LIDAR sensor, a millimeter wave RADAR sensor and an RGBD camera.

4. The elevator system of claim 2, wherein a running average of measured distances is indicative of movement of the tie-down compensation in the hoistway.

5. The elevator system of claim 2, wherein a run-to-run difference in measured distance is indicative of damping performance of the tie-down compensation.

6. The elevator system of claim 2, wherein the sensor is fixed in the hoistway and measures a position of the tie-down compensation.

7. The elevator system of claim 2, wherein the sensor is fixed to the tie-down compensation and measures a distance to the fixed location in the hoistway.

8. A method of monitoring a tie-down compensation of an elevator system, comprising:
positioning one or more sensor assemblies in a hoistway of the elevator system, the sensor assemblies configured to monitor a position of the tie-down compensation in the hoistway, the tie-down compensation having a compensation member of the elevator system routed therethrough;
measuring a distance between a fixed location in the hoistway and the tie-down compensation via the one or more sensor assemblies;
comparing the measured distance to a threshold distance; and
taking one or more actions based on a result of the comparison.

9. The method of claim 8, further comprising:
calculating a running average of the measured distance;
comparing the calculated running average to the threshold distance; and
shortening an effective length of the compensation member as a result of the comparison.

10. The method of claim 8, further comprising:
comparing measured distances on a run to run basis; and
taking one or more actions based on the compared measured distances.

11. The method of claim 8, further comprising:
determining one or more of a velocity or acceleration of the tie-down compensation;
comparing the velocity or acceleration to a threshold; and
taking one or more actions based on the compared velocity or threshold.

12. The method of claim 11, wherein the one or more actions includes replacement or replenishment of fluid in a hydraulic damper of the tie-down compensation.

13. The method of claim 8, wherein the sensor assemblies include at least one of a LIDAR sensor, a millimeter wave RADAR sensor and an RGBD camera.

14. The method of claim 8, wherein the sensor assemblies are fixed in the hoistway and measure a position of the tie-down compensation.

15. The method of claim 8, wherein the sensor assemblies are fixed to the tie-down compensation and measure a distance to the fixed location in the hoistway.

16. An elevator system comprising:
a hoistway;
an elevator car configured to travel in the hoistway;
a counterweight disposed in the hoistway;
a tension member extending between and connecting the elevator car to the counterweight;
a pit located at a bottom of the hoistway;
a compensation member extending from the elevator car toward the pit and from the pit toward the counterweight;
a tie-down carriage connected to the compensation member, wherein the tie-down carriage is configured to be biased downwardly toward the bottom of the hoistway to tension the compensation member; and
one or more LIDAR sensors configured to monitor a position of the tie-down carriage in the hoistway.

17. The elevator system of claim 16, wherein the one or more LIDAR sensors measures a distance between a fixed location in the hoistway and the tie-down carriage.

18. The elevator system of claim 16, wherein a running average of measured distances is indicative of movement of the tie-down carriage in the hoistway.

19. The elevator system of claim 16, wherein the one or more LIDAR sensors is fixed in the hoistway and measures a position of the tie-down carriage.

20. The elevator system of claim 16, wherein the one or more LIDAR sensors is fixed to the tie-down carriage and measures a distance to the fixed location in the hoistway.
